(19) United States
(12) Patent Application Publication
(10) Pub. No.: US 2014/0035894 A1
(43) Pub. Date: Feb. 6, 2014

(54) Three-Dimension LCD and the Driving Method

(71) Applicants: Chia-chiang Hsiao, Guangdong (CN); Chih-Wen Chen, Guangdong (CN)

(72) Inventors: Chia-chiang Hsiao, Guangdong (CN); Chih-Wen Chen, Guangdong (CN)

(73) Assignee: SHENZHEN CHINA STAR OPTOELECTRONICS TECHNOLOGY CO. LTD., Shenzhen (CN)

(21) Appl. No.: 13/638,908

(22) PCT Filed: Aug. 10, 2012
(86) PCT No.: PCT/CN12/79984

§ 371 Date: Oct. 1, 2012

(30) Foreign Application Priority Data
Aug. 3, 2012 (CN) 201210275118.6

(51) Int. Cl. G09G 3/36; G09G 5/18

(52) U.S. Cl. 345/208; 345/94

(57) ABSTRACT

The present invention discloses a method of driving a 3D LCD. The 3D LCD includes N data lines and 2M scan lines. The driving method includes that scanning two adjacent scan lines of 2M scan lines once a time in order in a first scanning period while outputting data correspondent to a first frame to the N data lines, and turning even number of the 2M scanning lines on in order in a second scanning period while outputting data of a second frame to the N data lines, wherein the first frame is for user's one eye, and the second frame is for user's the other eye.

### FIELD OF THE INVENTION

The present invention relates to a liquid crystal display (LCD) and a driving method, more particularly, to a three-dimension (3D) LCD and a driving method.

### DESCRIPTION OF THE PRIOR ART

There are some advantages for a LCD, such as lightness, slimness, low energy consuming, which are widely used in modern information devices, like computer, mobile phone and personal digital assistant. A conventional LCD are assembled by a LCD panel and a backlight module. The LCD panel mainly comprises an array substrate, a color filter substrate and a liquid crystal layer sandwiched between the two substrates. The array substrate comprises pixel area formed by pixel arrays.

There is a major trend for a 3D LCD capable of displaying 3D image because people have more and more demands for image display. The principle of 3D LCD shutter glasses is to use the concept of alternate-frame sequencing. The LCD alternates a left-eye frame and a right-eye frame in every 1/60 second and controls a switch of shutters in the glasses. The glasses blocks light for appropriate eye when the converse eye's image is displayed on the LCD, so that the left eye sees the left-eye frame and the right eye sees the right-eye frame. In the end, it synthesizes a 3D image in brain due to persistence and parallax of vision.

Please refer to FIG. 1, FIG. 1 demonstrates a timing diagram of three conventional 3D displays. Generally speaking, there are three kinds of 3D displays. One is a 3D display alternately outputting left-eye and right-eye frames with 120 Hz frame rate, another one is a 3D display alternately outputting two left-eye frames and two right-eye frames with 240 Hz frame rate, and the other is a 3D display using black frame between a left-eye frame and aright-eye frame with 240 Hz frame rate.

As the one skilled in the art is aware, a crosstalk function is used to evaluate the display quality of the 3D display, and is defined as follow:

crosstalk=[L(WB)−L(BB)]/[L(BW)−L(BB)] (1)

where L(WB) represents a lightness of the displaying image when the left-eye frame is white and the right-eye frame is black, L(BB) represents a measured lightness of the displaying image when the left-eye frame and the right-eye frame are black, and L(BW) represents a lightness of the displaying image when the left-eye frame is black and the right-eye frame is white, all the parameters are obtained by measuring the lightness of the display through right glass. The less crosstalk indicates that it is not visible to the left-eye frame for the right eye by means of the right glass, and results in a better 3D display quality.

In hence, it is necessary to develop a 3D display having less crosstalk to upgrade 3D display quality.

### SUMMARY OF THE INVENTION

The object of the present invention is to provide a 3D LCD and a driving method for effectively decreasing crosstalk to improve the 3D display quality of the 3D LCD.

According to the present invention, a method of driving a 3D LCD is provided. The 3D LCD comprises N data lines and 2M scan lines. The method comprises: sequentially turning on two adjacent scan lines of 2M scan lines once a time in a first scanning period while outputting data correspondent to a first frame to the N data lines; and sequentially turning on even number of the 2M scanning lines in a second scanning period while outputting data of a second frame to the N data lines. The first frame is viewed by user's one eye, and the second frame is viewed by user's the other eye.

In one aspect of the present invention, the first scanning period is equal to the second scanning period.

In another aspect of the present invention, the first scanning period is 1/240 second.

In another aspect of the present invention, the second scanning period is 1/240 second.

In another aspect of the present invention, the second scanning period is adjacent to the first scanning period.

According to the present invention, a 3D LCD comprises: N data lines and 2M scan lines; a gate driving module for sequentially turning on two adjacent scan lines of 2M scan lines once a time in a first scanning period and sequentially turning even number of the 2M scanning lines on in order in a second scanning period; and a source driving module coupled to the N data lines for outputting data of a first frame in the first scanning period and data of a second frame to the N data lines in the second scanning period. The first frame is viewed by user's one eye, and the second frame is viewed by user's the other eye.

In one aspect of the present invention, the first scanning period is equal to the second scanning period.

In another aspect of the present invention, the first scanning period is 1/240 second.

In another aspect of the present invention, the second scanning period is 1/240 second.

In another aspect of the present invention, the second scanning period is adjacent to the first scanning period.

The advantage of the present invention is that the 3D display is capable of decreasing crosstalk to improve 3D image display quality. It takes only half time for scanning a whole image because the present invention scans two scan lines once a time. In hence, the present invention just spends 1/240 second scanning an image when it drives at 120 Hz frame rate.

These and other features, aspects and advantages of the present disclosure will become understood with reference to the following description, appended claims and accompanying figures.

### BRIEF DESCRIPTION OF THE DRAWINGS

FIG. 1 demonstrates a timing diagram of three conventional 3D displays.

FIG. 2 illustrates a LCD panel.

FIG. 3 shows a relation between transmittances of each of the region, the region and the region and time when the LCD panel scans at 120 Hz frame rate.

FIG. 4 illustrates a crosstalk curve diagram of the LCD panel in the vertical direction.

FIG. 5 illustrates another LCD panel.

FIG. 6 shows a relation between liquid crystal transmittance of each of the region, the region and the region and time when the LCD panel scans at 240 Hz frame rate.

FIG. 7 illustrates a crosstalk curve of the LCD panel in the vertical direction.

FIG. 8 shows a diagram of a 3D LCD according to an embodiment of the present invention.

FIG. 9 is a timing diagram of driving the 3D LCD.

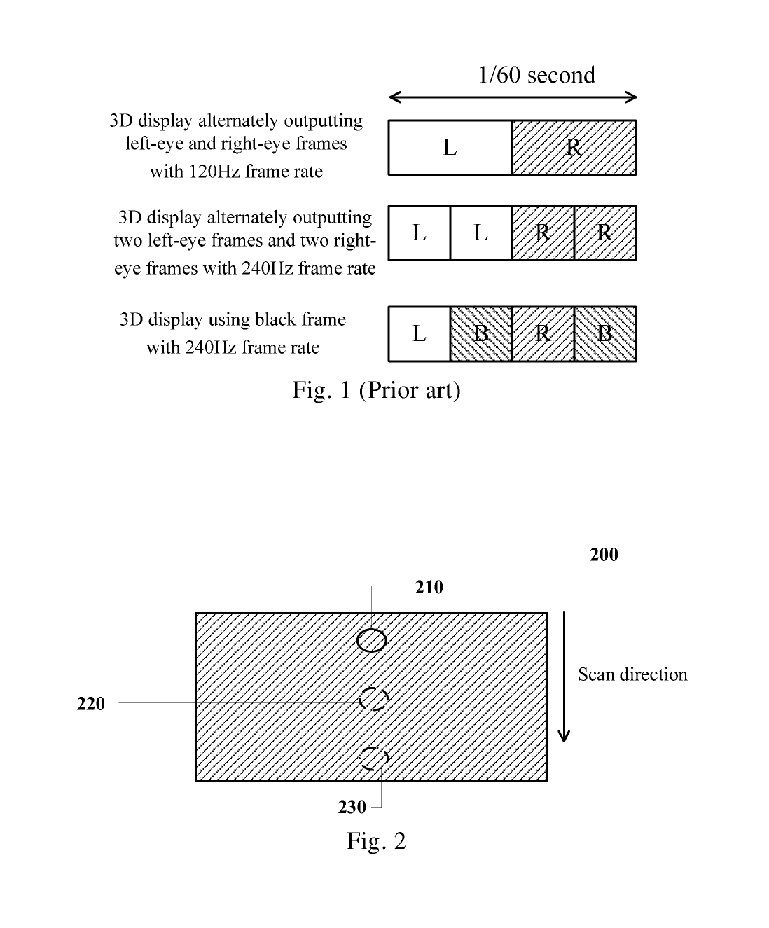

### DETAILED DESCRIPTION OF THE PREFERRED EMBODIMENTS

For better understanding embodiments of the present invention, the following detailed description taken in conjunction with the accompanying drawings is provided. Apparently, the accompanying drawings are merely for some of the embodiments of the present invention. Any ordinarily skilled person in the technical field of the present invention could still obtain other accompanying drawings without use laborious invention based on the present accompanying drawings.

Referring to FIG. 2, FIG. 2 illustrates a LCD panel 200. The LCD panel 200 scans at 120 Hz frame rate, in which a region 210, a region 220 and a region 230 respectively stand for upper, middle and lower region of the LCD panel 200. The direction of arrow in FIG. 2 means the scanning direction of the LCD panel 200. The LCD panel 200 generally scans from top to bottom.

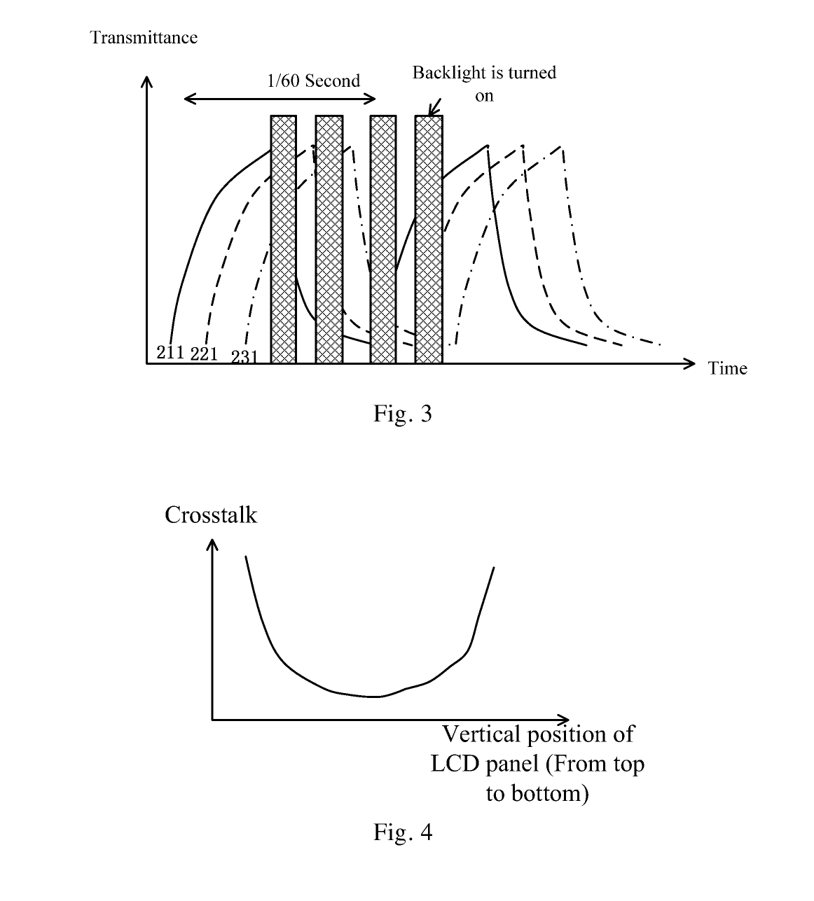

Referring to FIG. 3 showing a relation between transmittances of each of the region 210, the region 220 and the region 230 and time when the LCD panel 200 scans at 120 Hz frame rate, a line segment 211 means transmittance of the region 210, a line segment 221 means transmittance of the region 220 and a line segment 231 means transmittance of the region 230. The liquid crystal transmittance of the upper region 210, the middle region 220 and the lower region 230 in the LCD panel 200 is much different from each other at the same time because it takes longer to scan from top to bottom when the LCD panel 200 scans at 120 Hz frame rate. Take a backlight of two regions for instance. On the one hand, the upper part (the region 210) is brighter and the lower part (the region 230) is darker in a white image because the transmittance of the upper part (the region 210) of the LCD panel 200 is higher than that of the lower part(the region 230) as it turns the backlight of the upper part on. On the contrary, the upper part(the region 210) is darker and the lower part (the region 230) is brighter because the transmittance of the upper part (the region 210) of the LCD panel 200 is lower than that of the lower part(the region 230) as it turns the backlight of the lower part on. On the other hand, the upper part(the region 210) is darker and the lower part (the region 230) is brighter in a black image because the transmittance of the upper part (the region 210) of the LCD panel 200 is lower than that of the lower part(the region 230) as it turns the backlight of the upper part on and vice versa.

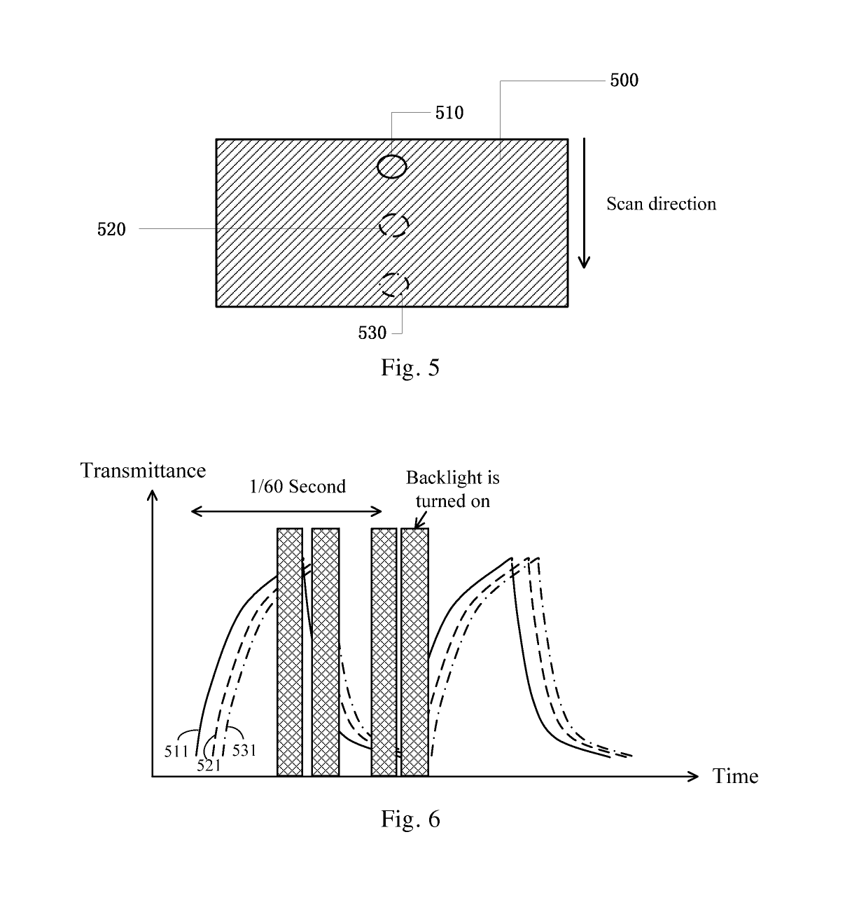

Referring to FIG. 4, FIG. 4 illustrates a crosstalk curve diagram of the LCD panel 200 in the vertical direction. The crosstalk of the LCD panel 200 in the vertical direction is lowest in the middle of the panel (correspondent to the region 220) and is relatively higher on top and bottom sides (correspondent to the region 210 and the region 230).

Referring to FIG. 5, FIG. 5 illustrates another LCD panel 500. The LCD panel 500 scans at 240 Hz frame rate, wherein a region 510, a region 520 and a region 530 respectively stand for upper, middle and lower region of the LCD panel 500. The direction of arrow in FIG. 5 means the scanning direction of the LCD panel 500. The LCD panel 500 generally scans from top to bottom.

Referring to FIG. 6 showing a relation between liquid crystal transmittance of each of the region 510, the region 520 and the region 530 and time when the LCD panel 500 scans at 240 Hz frame rate, a line segment 511 means transmittance of the region 510, a line segment 521 means transmittance of the region 520 and a line segment 531 means transmittance of the region 530. Please pay attention that difference of the liquid crystal transmittance of the upper region 510, the middle region 520 and the lower region 530 in the LCD panel 500 is not quite large at the same time because it takes shorter to scan from top to bottom when the LCD panel 500 scans at 240 Hz frame rate. Take a backlight of two regions for instance. On the one hand, the difference of brightness between the upper part (the region 210) and the lower part (the region 230) is not quite large in a white image because the transmittance of the lower part (the region 530) of the LCD panel 500 is lower than that of the upper part (the region 510), and the difference of the LCD panel 500 is smaller than that of the LCD panel 200 at 120 Hz as it turns the backlight of the upper part on. On the contrary, brightness between the upper part and the lower part is similar as it turns the backlight of the lower part on.

On the other hand, brightness of the upper part (the region 510) and the lower part (the region 530) is not quite different from each other in a black image because the transmittance of the upper part and the lower part of the LCD panel 200 is low as it turns the backlight of the upper part on. On the contrary, brightness of the upper part (the region 510) and the lower part (the region 530) is not quite different from each other because the transmittance of the upper part and the lower part of the LCD panel 200 is low as it turns the backlight of the lower part on.

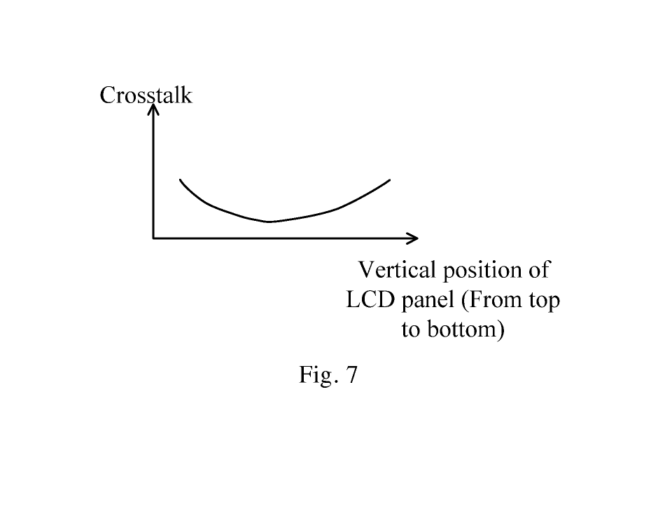

Referring to FIG. 7, FIG. 7 illustrates a crosstalk curve of the LCD panel 500 in the vertical direction. The crosstalk distribution of the LCD panel 500 in the vertical direction is similar with that of the LCD panel 200. The crosstalk is lowest in the middle of the panel (correspondent to the region 520) and is relatively higher on top and bottom sides (correspondent to the region 510 and the region 530). But please take a notice that comparing with FIG. 4 and FIG. 7, the crosstalk of the LCD panel 500 is not only relatively lower than that of the LCD panel 200 but also the difference of the crosstalk between the top, bottom sides and the middle part is relatively smaller.

That is the character the present invention uses to decrease crosstalk of a LCD panel.

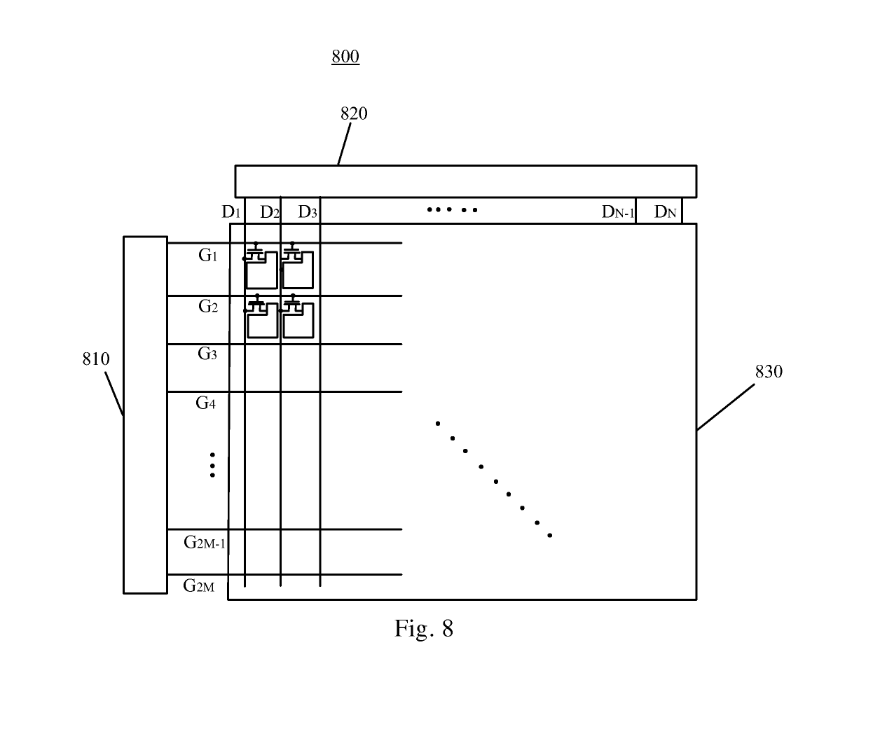

Please referring to FIG. 8, FIG. 8 shows a diagram of a 3D LCD 800 according to an embodiment of the present invention. The 3D LCD 800 comprises a gate driving module 810, a data driving module 820 and a LCD panel 830. The LCD panel 830 comprises the N number of data lines (D₁˜D_{N}) overlapped mutually and the 2M number of scan lines (G₁˜G_{2M}). The gate driving module 810 is coupled to the scan lines G₁˜G_{M} and used for driving the scan lines in the LCD panel 830. The data driving module 820 is coupled to the scan lines D₁˜D_{N} and used for outputting the data about being displayed to the data lines D₁˜D_{N}.

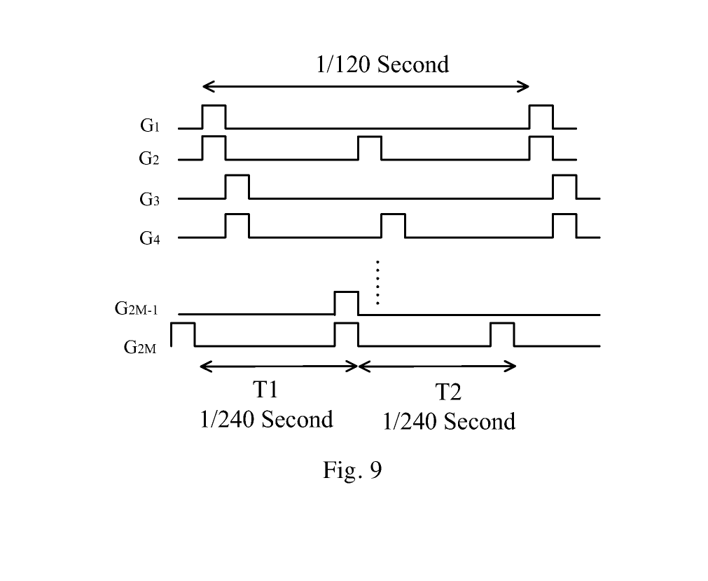

Please go on to refer to FIG. 9. FIG. 9 is a timing diagram of driving the 3D LCD 800. As FIG. 9 shows, there are two periods of scanning period in the present invention, the first scanning period T1 and the second scanning period T2. Please take a notice that the second scanning period T2 is next to the first scanning period T1, and both correspond to 1/240 second in the embodiment.

As the 3D LCD 800 has to mutually display left-eye frames and right-eye frames, it displays one of the images (like the left-eye frame) in the first scanning period T1 and displays the other (like the right-eye frame) in the second scanning period T2.

The operation in the present invention is:

The gate driving module 810 scans two adjacent scan lines of the LCD panel 830 once a time in the first scanning period T1 while the data driving module 820 is outputting the data correspondent to one image (such as the mentioned left-eye frame) to the data lines D₁˜D_{N}. The driving method of the gate driving module 810 in the embodiment demonstrates in FIG. 9 that it drives the scan lines G1 and G2 first, the scan lines G3 and G4 next and scans all the scan lines G₁˜G_{2M} in the order of two adjacent scan lines as an unit. In the meantime, the data driving module 820 is outputting the data correspondent to one image (such as the mentioned left-eye frame) to the data lines D₁˜D_{N} to display the data of the whole image (such as the mentioned left-eye frame) in the LCD panel 830.

And then, the gate driving module 810 scans the even number of the scan lines (G₂, G₄, G₆ . . . G_{2M}) of the LCD panel 830 once a time in the second scanning period T2 while the data driving module 820 is outputting the data correspondent to one image (such as the mentioned right-eye frame) to the data lines D₁˜D_{N}. The driving method of the gate driving module 810 in the embodiment demonstrates in FIG. 9 that it drives the scan line G2 first and the scan line G4 next, and scans all even number of the scan lines G₂, G₄, G₆ . . . G_{2M} in order. In the meantime, the data driving module 820 is outputting the data correspondent to one image (such as the mentioned right-eye frame) to the data lines D₁˜D_{N} to display the data of the whole image (such as the mentioned right-eye frame) in the LCD panel 830.

It is noted that the 3D LCD 800 just spends half of the time on scanning because the 3D LCD 800 scans two scan lines a time or half of the all scan lines. The driving method for the 3D LCD 800 that spends 1/240 second on scanning the first frame (the left-eye frame) or the second frame (the right-eye frame) in the embodiment is similar to that for the mentioned 240 Hz panel. Therefore, the transmittances of areas in the LCD panel 830 are more convergent, and the crosstalk of the LCD panel 830 is less than that of a LCD panel using 120 Hz frame rate, such that the uniformity of the LCD panel 830 is better than that of LCD panel using 120 Hz frame rate.

It is not limited by the order in the present invention that the LCD 800 outputs the left-eye frame first and then the right-eye frame. In practical, the LCD 800 outputting the right-eye frame first and then the left-eye frame is also in the scope of the present invention.

Compared with the prior art, the LCD 800 of the present invention has less crosstalk and better uniformity to upgrade 3D image quality.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. A method of driving a 3D LCD, the 3D LCD comprising N data lines and 2M scan lines, the driving method comprising:
sequentially turning on two adjacent scan lines of 2M scan lines once a time in a first scanning period while outputting data correspondent to a first frame to the N data lines; and
sequentially turning on even number of the 2M scanning lines in a second scanning period while outputting data of a second frame to the N data lines;
wherein the first frame is viewed by user's one eye, and the second frame is viewed by user's the other eye.

2. The method of claim 1, wherein the first scanning period is equal to the second scanning period.

3. The method of claim 1, wherein the first scanning period is 1/240 second.

4. The method of claim 1, wherein the second scanning period is 1/240 second.

5. The method of claim 1, wherein the second scanning period is adjacent to the first scanning period.

6. A 3D LCD, comprising:
N data lines and 2M scan lines;
a gate driving module for sequentially turning on two adjacent scan lines of 2M scan lines once a time in a first scanning period and sequentially turning even number of the 2M scanning lines on in order in a second scanning period; and
a source driving module coupled to the N data lines for outputting data of a first frame in the first scanning period and data of a second frame to the N data lines in the second scanning period;
wherein the first frame is viewed by user's one eye, and the second frame is viewed by user's the other eye.

7. The 3D LCD of claim 6, wherein the first scanning period is equal to the second scanning period.

8. The 3D LCD of claim 6, wherein the first scanning period is 1/240 second.

9. The 3D LCD of claim 6, wherein the second scanning period is 1/240 second.

10. The 3D LCD of claim 6, wherein the second scanning period is adjacent to the first scanning period.
